(19) United States
(12) Patent Application Publication
(10) Pub. No.: US 2026/0097470 A1
(43) Pub. Date: Apr. 9, 2026

(54) ADJUSTABLE OPENING PLIERS

(71) Applicant: SNA EUROPE INDUSTRIES IBERIA, S.A., VITORIA (ES)

(72) Inventors: Xabier ARRIZABALAGA IRAEGUI, VITORIA (ES); Asier SÁEZ DE CASTILLO APODACA, VITORIA (ES); Mikel ETXAGIBEL MARTÍNEZ DE MARIGORTA, VITORIA (ES)

(73) Assignee: SNA EUROPE INDUSTRIES IBERIA, S.A., VITORIA (ES)

(21) Appl. No.: 19/351,665

(22) Filed: Oct. 7, 2025

(30) Foreign Application Priority Data
Oct. 8, 2024 (ES) P202430805

(51) Int. Cl. B25B 7/10

(52) U.S. Cl. CPC B25B 7/10

(57) ABSTRACT

The adjustable opening pliers comprises a passive male shank and an active female shank each with a handle an intermediate section and a jaw The male shank has a longitudinal slot with teeth on its lower edge. The female shank has a transverse channel for partial insertion of the male shank and a through side bore. The adjustment mechanism includes a ratchet, attachable with the teeth, and a shaft coupled in the side bore, configured to interact with the ratchet. When the female shank is rotated, the shaft stem rotates the ratchet, disengaging it from the teeth, which allows the relative position between the male shank and the female shank to be adjusted in a precise and controlled manner. In an alternative embodiment, the female shank comprises a movable jaw guided along the male shank by a guide, so that the jaws remain substantially parallel during adjustment and use.

### OBJECT OF THE INVENTION

The present invention falls within the technical field of manual clamping and tightening tools with jaws at pivoting ends, more specifically within that of those tools with joints with adjustable support point, and relates in particular to adjustable pliers allowing the variation of the opening of their jaws.

### BACKGROUND OF THE INVENTION

Pliers are essential tools in a wide range of industries, from mechanics to construction, to home and professional applications. Over the years, different types of pliers have been designed to perform specific functions, such as tightening, loosening, holding, or adjusting parts. One of the most sought-after features in that kind of tool is its ability to adjust to different sizes of objects, which gave rise to adjustable pliers. These tools allow the jaws to be varied in order to cover a greater diversity of shapes and dimensions, increasing their versatility and usefulness.

Adjustable pliers have evolved to meet the need for adaptability in uses where workpieces of different sizes are handled. Unlike fixed-size pliers, which can only grip objects within a specific range of diameters, adjustable pliers allow the distance between the jaws to be varied, significantly expanding the range of possible applications. This type of pliers is especially useful in repair, maintenance and assembly uses, where operators need to quickly change between workpieces of different dimensions without resorting to multiple tools.

However, despite advances in the design of adjustable pliers, several problems persist with conventional designs. A common problem is the complexity of adjustment mechanisms. In many adjustable pliers, the opening and closing system is controlled by a ratchet mechanism, a bolt, or a combination of moving parts that allow the jaw opening to be varied.

Another major issue is ergonomics and ease of use. Many designs require the user to adjust with both hands, or use additional tools, reducing its efficiency and complicating its use in tight spaces or situations where maneuverability is limited. This factor worsens when it is considered that the adjustment mechanism may not be ambidextrous, limiting its accessibility for right and left-handed users alike. In contexts where speed and precision are essential, such as in mechanical or construction work, a tool that cannot be quickly and easily adjusted can negatively impact productivity.

A third common drawback of adjustable pliers is the durability and reliability of the locking mechanism. In many cases, once the desired opening has been set, the locking system does not properly secure the position of the jaws, which can result in unwanted slippage during use. Not only does this type of failure disrupt the workflow, but it also poses a potential risk to the safety of the operator and can damage the parts being handled. In addition, wear and tear on the adjustment and locking mechanism, due to prolonged use, can exacerbate these problems over time.

It should also be noted that in some current adjustable pliers designs, the number of additional components, such as pins, bolts, and ratchets, increases the likelihood of mechanical failure. Each additional component not only increases the cost of manufacturing but can also create weak points in the tool's structure, especially if low-quality materials are used or assembly is not precise. Additionally, maintenance of these tools becomes more complicated due to the difficulty in properly disassembling and reassembling the internal mechanism.

In the current state of the art, there are known documents related to adjustable pliers of this type. An example can be found in document ES2682076, owned by this same applicant, describing an adjustable pliers that have a movable active arm with a transverse recess of two branches, between which there is a passive arm that has a longitudinal slot provided with at least one inclined tooth, and there being a movable axis fixed to the movable active arm, housing a ratchet locking piece having on one side a locking tooth facing said inclined tooth, and the ratchet locking piece having an elastic spring; in which the ratchet locking piece has an angular slot capable of receiving within it a fixed pin linked to the movable active arm.

In summary, adjustable pliers have represented a significant advancement in terms of versatility and functionality in a wide variety of applications. However, significant problems remain regarding the complexity of the design, ergonomics, reliability of the adjustment mechanism and overall durability of the tool. The present invention has been developed to address these shortcomings by providing a more simplified and efficient design, improving the accuracy of adjustment, ensuring locking security and facilitating use for a wider variety of users and situations.

### DESCRIPTION OF THE INVENTION

The object of the invention consists of a pair of pliers with adjustable opening that allows the opening of its jaws to be varied. The main objective of the invention is to overcome the deficiencies of the state of the art by creating a pair of pliers with adjustable width incorporating a simplified and ambidextrous ratchet system, improving both the ease of adjustment and the durability of the mechanism.

The specific objectives of the invention include:
reducing the number of components required for the adjustment mechanism, eliminating dependence on the pin or button present in other solutions;
simplifying tool assembly by implementing a mechanism based on an axis with optimized geometry that interacts directly with the ratchet;
providing an ambidextrous solution that allows a comfortable adjustment for both right-and left-handed users, by rotating the movable shank;
improving the durability of the mechanism, using materials and designs that minimize wear over time.

The present invention relates to an adjustable opening pliers incorporating an adjustment mechanism by means of a detachable ratchet system, allowing precise variation of the opening of the jaws to adapt to objects of different sizes. The invention facilitates the adjustment of the tool without the need to use auxiliary tools, improving its operability.

The main mechanism consists of two clamping arms articulated at a pivot point. Opening adjustment is achieved by a geometric axis, which interacts with the ratchet. The axis has a stem that has at least two flat sides that, upon reaching a specific angle of rotation, interact with the central hole of the ratchet and allow it to disengage, allowing the opening of the jaws to be varied. Unlike other designs that use pins, buttons or bolts, the present system uses a direct axis, reducing the number of moving components and simplifying the construction of the mechanism.

During use, as the female shank of the pliers is rotated, the flat sides on the shaft stem contact the internal surfaces of the central hole of the ratchet. This contact causes the ratchet to rotate integrally with the shaft, allowing the ratchet to disengage from the teeth on the male shank. Once the required angle for disengagement has been exceeded, the user can freely adjust the opening of the jaws. When the desired opening is selected, the ratchet automatically re-engages, ensuring that the jaws maintain their position during use.

The design allows for one-handed opening adjustment, making it easy to use in a variety of applications without the need to manipulate multiple mechanisms simultaneously. The adjustment system is ambidextrous, allowing use by both right-and left-handed users. The ratchet and geometric axis mechanism ensures reliable locking of the jaws, minimizing the risk of inadvertent movement.

The geometric axis can take different shapes depending on the specific requirements of use. While the preferred embodiment uses two flat sides, it is possible to implement variants with more sides or curved surfaces, which could offer different levels of adjustment or stability depending on the context of use. In addition, the axis can have a polygonal configuration, such as a hexagonal axis, to increase the precision of the adjustment.

In an alternative embodiment, the pliers are configured such that the jaws remain substantially parallel to each other during the adjustment and use of the tool. In this configuration, the female shank is divided into two functional portions, namely the movable shank itself and a separate movable jaw. The movable jaw is arranged in a guided manner with respect to the male shank, so that, when the female shank is rotated to disengage the ratchet from the teeth of the male shank and the relative position between both shanks is adjusted, the movable jaw slides in parallel with the fixed jaw of the male shank.

This arrangement ensures that the facing surfaces of the jaws remain parallel, irrespective of the selected opening. The guidance of the movable jaw along the male shank provides a stable geometry in which the clamping surfaces of both jaws are always aligned, thereby preventing angular deviations that could occur in conventional adjustable pliers.

The operation of the adjustment mechanism is substantially the same as in the preferred embodiment already described. When the female shank is rotated beyond a certain angle, the shaft stem contacts the inner surfaces of the central hole of the ratchet and causes the ratchet to rotate with the shaft, disengaging it from the teeth of the male shank. At that point, the female shank can slide relative to the male shank in order to vary the opening of the jaws. Once the desired opening is selected, the ratchet automatically re-engages with the teeth, locking the position.

The technical effect of this configuration is a significant improvement in the quality and safety of the grip. By maintaining the jaws parallel, the pressure exerted on a flat or prismatic workpiece is distributed uniformly, reducing the risk of damage to the part and ensuring a more secure retention. This embodiment is especially advantageous for holding objects with flat or parallel surfaces, such as nuts, plates, bars or connectors, where parallelism of the jaws contributes to both precision and operator safety.

As for materials, the shaft and ratchet can be made from wear-resistant metal alloys or composite materials, depending on the tool's durability needs. Using these materials can ensure a longer life cycle and greater fatigue resistance, especially in industrial applications.

### DESCRIPTION OF THE DRAWINGS

To complement the description being made and in order to assist in a better understanding of the characteristics of the invention, in accordance with a preferred example of its practical implementation, a set of drawings is included as an integral part of said description, in which, for illustrative and non-limiting purposes, the following has been represented:

FIG. 1.—Shows a perspective view of the adjustable opening pliers.

FIG. 2.—Shows a perspective view of an exploded view of the pliers.

FIG. 3.—Shows a plan view of the pliers and indicates a section.

FIG. 4.—Shows a bottom plan view of the pliers and indicates a section.

FIG. 5.—Shows a plan view of the pliers sectioned by plane A-A in FIG. 4.

FIG. 6.—Shows a front view of the pliers sectioned by plane B-B in FIG. 3.

FIG. 7.—Shows a rear perspective view of the male shank and part of the adjustment mechanism.

FIG. 8.—Shows a front perspective view of FIG. 7.

FIGS. 9.1-9.3.—Show the adjusting sequence of the opening of the pliers.

FIG. 10.—Shows a perspective view of the alternative embodiment of the pliers with parallel jaws.

FIG. 11.—Shows a perspective view of an exploded view of the alternative embodiment of the pliers.

FIGS. 12.1-13.3—Show the adjusting sequence of the opening of the alternative embodiment of pliers.

### PREFERRED EMBODIMENT OF THE INVENTION

A detailed explanation of a preferred embodiment of the object of the present invention is provided below with the aid of the figures referred to above.

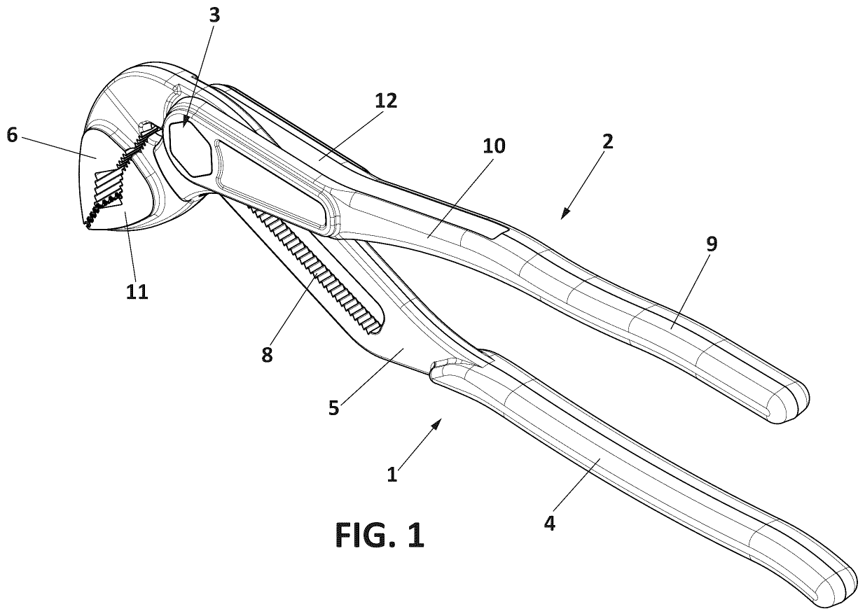

The adjustable opening pliers described, shown in FIG. 1, comprise a passive or fixed shank, hereinafter referred to as the male shank, (1) and an active or movable shank, hereinafter referred to as the female shank (2), linked together by an adjustment mechanism (3).

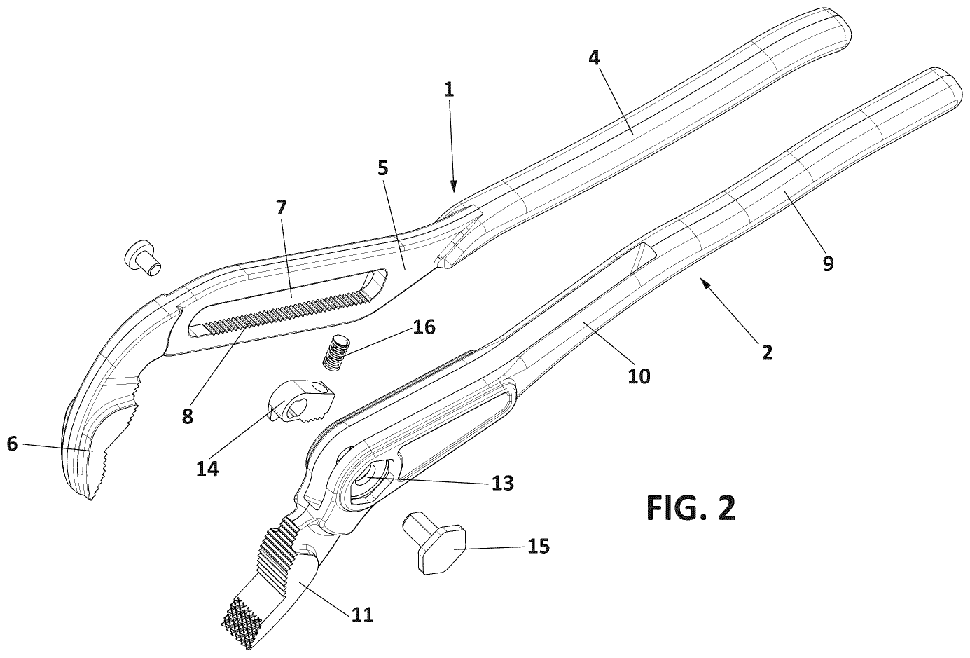

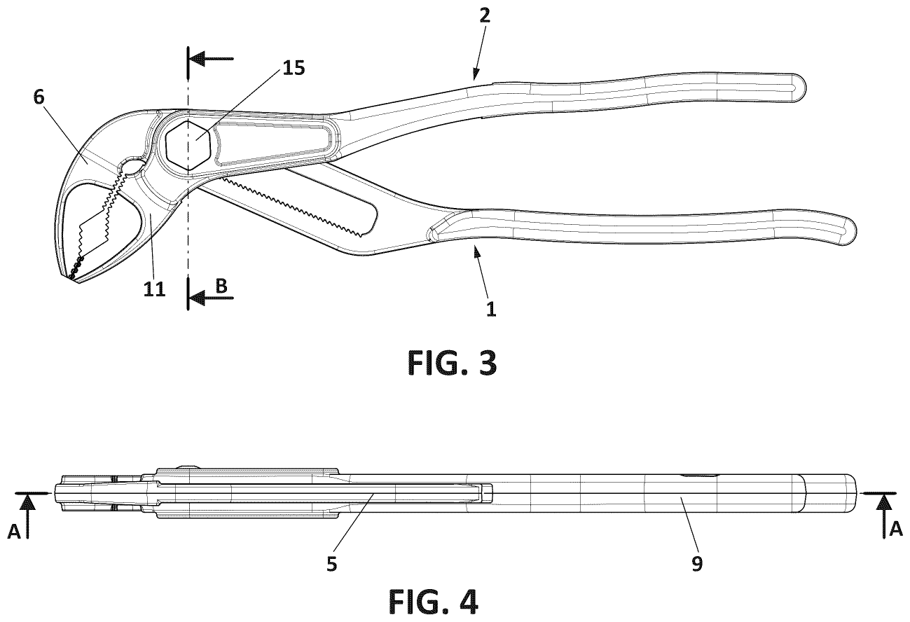

As can be seen in the exploded view of FIG. 2, the male shank (1) comprises, consecutively, a first lower handle (4), a first intermediate sector (5) and a first jaw (6). In the first intermediate sector (5) there is a longitudinal through slot (7), with teeth (8) defined on its lower internal edge.

For its part, the female shank (2) comprises, consecutively, a second lower handle (9), a second intermediate sector (10) and a second jaw (11). The second intermediate sector (10) has a transverse through channel (12), for partial insertion of the male shank (1) and the adjustment mechanism (3), and a perpendicular and through side bore (13), which passes through the female shank (2) at the end of the transverse channel (12) closest to the second jaw (11).

In this way, the gripping handle of the pliers is made up of the first handle (4) and the second handle (9), while the jaw is made up of the first jaw (6) and the second jaw (11). The first jaw (6) has an adjustable position relative to the second jaw (11), so the jaw has a variable opening.

The adjustment mechanism (3) is made up of a ratchet (14), provided with a central through hole, which can be engaged and disengaged in the teeth (8) by means of a shaft (15) running perpendicularly through the ratchet (14) through its central hole and which has a stem with a geometry such that it allows its interaction with the internal surfaces of said hole. In the most preferred embodiment, the stem has a polygonal geometry with at least two flat sides. In the preferred embodiment being described here, the stem of the shaft (15) has four flat sides, as can be seen in the figures. In alternative embodiments, the stem of the shaft (15) can have any geometry connecting the shaft (15) with the ratchet (14).

An elastic element (16) ensures that the ratchet (14) lever is always pressed against the teeth (8), allowing the adjustment mechanism (3) to operate automatically when adjusting the pliers and preventing movements in the opposite direction. In addition, it helps to release the ratchet (14) from the teeth (8) when the modification of the opening of the jaws (6,11) is wanted.

The flat-faced shaft (15) can be attached to the female shank (2) as it can be coupled to the side bore (13). In this way, the ratchet (14) can be operated by turning the female shank (2).

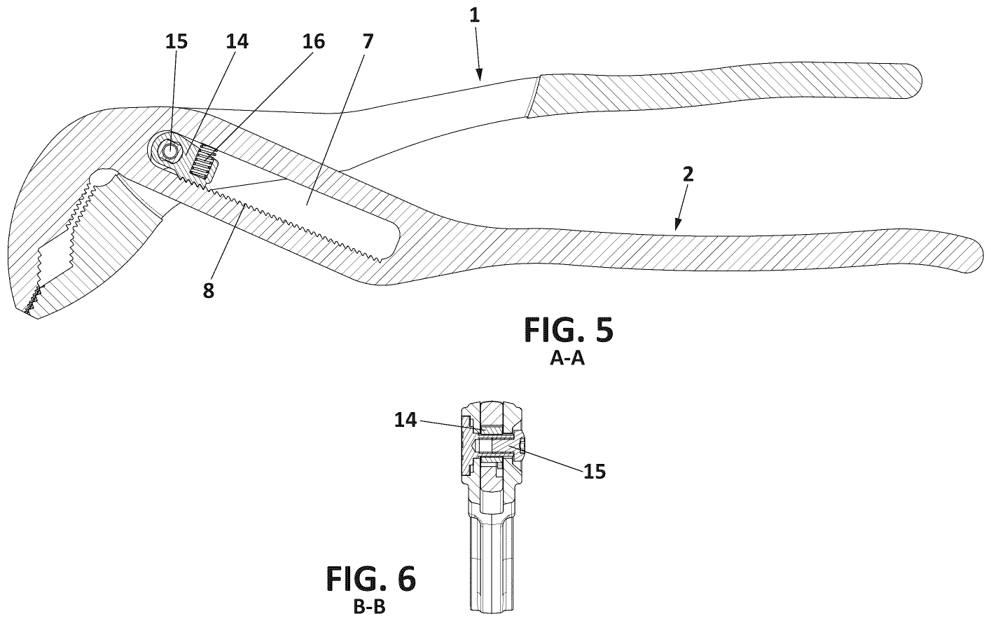

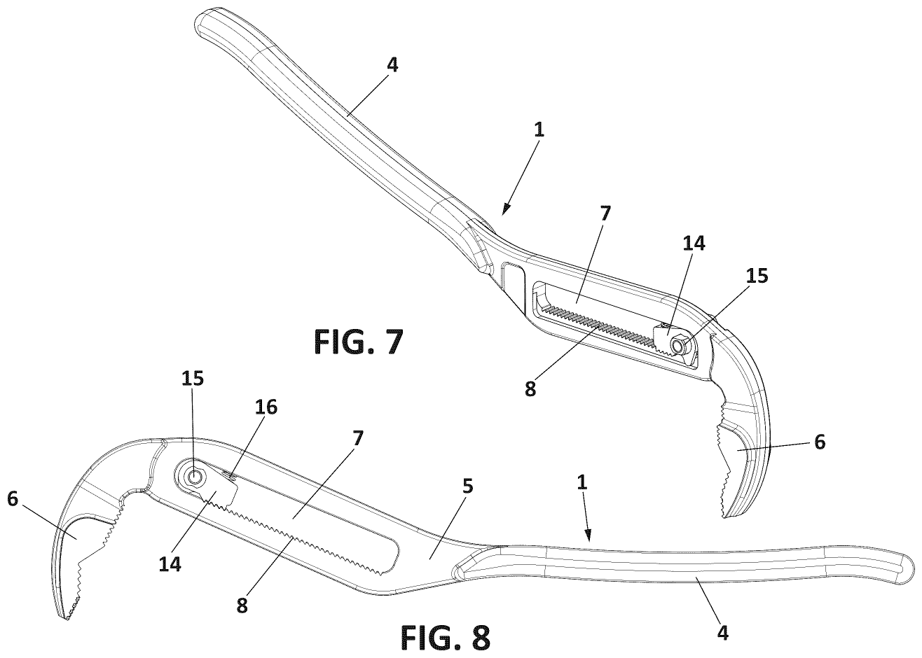

FIGS. 5 and 6 show the pliers in the rest position, with the jaws (6,11) very close to each other. The ratchet (14) is engaged with the teeth (8) and pressed by the elastic element (16), so that the male shank (1) is immobilized with respect to the female shank (2). FIGS. 7 and 8 show a partial exploded view of the pliers in FIGS. 5 and 6, which show the male shank (1) with the ratchet (14) housed in the longitudinal slot (7) and engaged in the teeth (8).

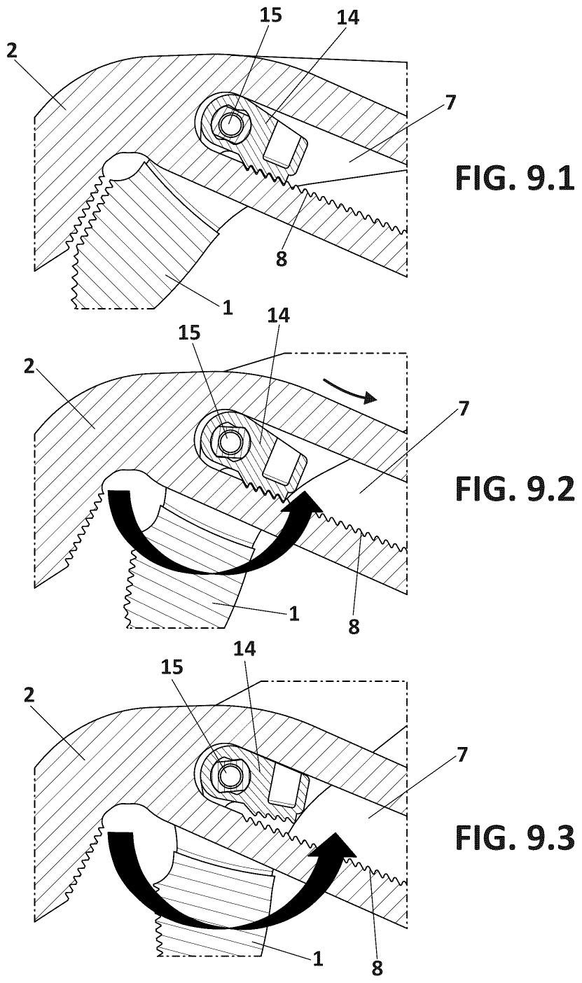

The procedure for disengaging the ratchet (14) is considered ambidextrous since it is activated by turning the female shank (2), as illustrated in FIGS. 9.1-9.3, without the need for any additional element located on the right or left side of the pliers. When a certain angle of rotation of said female shank (2) is exceeded, the ratchet (14) disengages from the teeth (8), so that the male shank (1) is released. At this point, the position of the male shank (1) with respect to the female shank (2) can be adjusted, to position the first jaw (6) at a greater or lesser separation from the second jaw (11) thus having the desired opening of the jaw.

To explain this procedure with reference to the shaft (15) with a flat-faced stem, it can be mentioned that when the female shank (2) is rotated, the shaft (15) rotates within the hole of the ratchet (14). The ratchet (14) continues to keep its teeth in contact with the teeth (8) of the longitudinal slot (7) of the male shank (1) until a certain angle is exceeded. At this moment, the shaft (15) stem, which in this case is flat faced, contacts the internal sides of the central hole of the ratchet (14), so that they are locked together, and the ratchet (14) begins to rotate together with the shaft (15). The ratchet (14) loses contact with the teeth (8), freeing the male shank (1) to adjust the position of said male shank (1) with respect to the female shank (2).

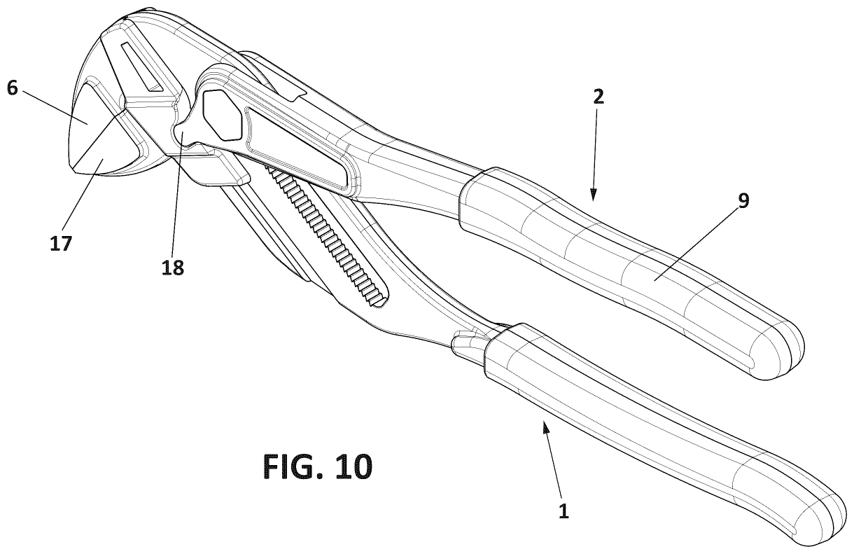

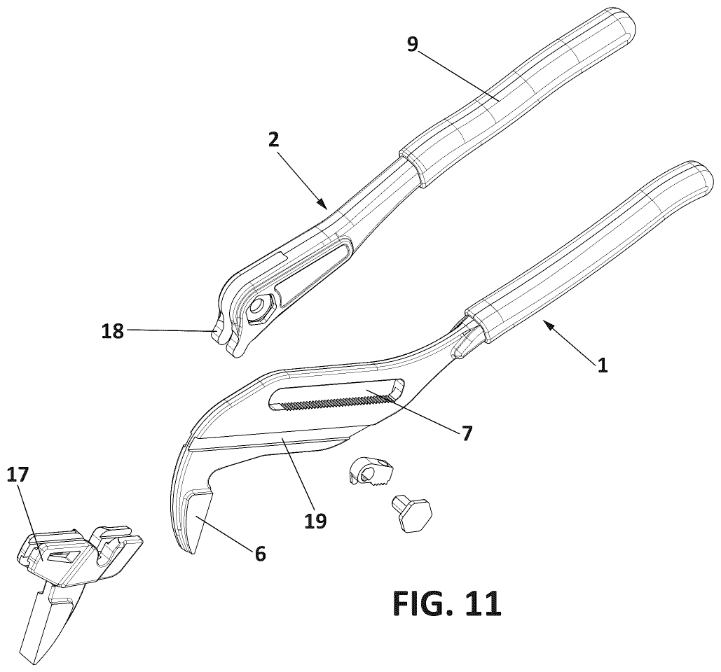

In an alternative embodiment, shown on FIGS. 10-12, the pliers are configured so that the facing clamping surfaces of the jaws (6,11) remain substantially parallel to each other during adjustment and use. In this configuration, the female shank (2) is functionally divided into the movable shank itself and a separate movable jaw (17). The female shank (2) further comprises a protruding part (18) located on an end opposite to that on which the second lower handle (9) is located, as it can be seen on FIG. 11. The protruding part (18) couples the female shank (2) with the movable jaw (17).

The male shank (1) further comprises a guide (19) arranged beneath the longitudinal through slot (7), so that the protruding part (18) of the female shank (2), through which it is attached to the movable jaw (17) is displaced in a guided manner along longitudinal slot (7). In this way, when the relative position between both shanks (1,2) is varied, the movable jaw (17) translates in a guide manner along the guide (19), pushed by the protruding part (18), while preserving its parallel orientation with the first jaw (6). In this embodiment, the second jaw (11) is implemented as the movable jaw (17) associated with the female shank (2), which is constrained by the cooperation between the protruding part (18) and the guide (19) to perform substantially linear motion relative to the male shank (1).

As in the embodiment previously described, the adjustment mechanism (3) comprises the ratchet (14), which is engageable with the teeth (8) provided on the lower internal edge of the longitudinal slot (7) of the male shank (1), and the shaft (15), which is attachable in the side bore (13) of the female shank (2). The elastic element (16) biases the ratchet (14) towards the teeth (8) so as to maintain the relative position selected during use. The structural difference of the present embodiment resides in that the movable jaw (17) cooperates with the male shank (1) through the protruding part (18) and the guide (19), which can be realized by mutually cooperating linear guide surfaces arranged along the corresponding portions of the male shank (1) and the movable jaw (17), thereby constraining their relative movement and maintaining parallelism of the clamping surfaces.

FIGS. 10 and 11 illustrate the general arrangement of this alternative embodiment. In the rest position, the ratchet (14) is engaged with the teeth (8) and the male shank (1) is immobilized relative to the female shank (2), while the movable jaw (17) is aligned with the first jaw (6) so that the clamping surfaces are substantially parallel. The operation of the adjustment mechanism (3) is analogous to that already described: when the female shank (2) is rotated beyond a certain angle, the stem of the shaft (15) contacts the internal surfaces of the central hole of the ratchet (14) and causes the ratchet (14) to rotate integrally with the shaft (15), thereby disengaging the ratchet (14) from the teeth (8).

Once disengagement has been produced, the opening of the jaws (6,11) can be varied by sliding the female shank (2) with respect to the male shank (1). During this adjustment, the movable jaw (17), which is attached to the protruding part (18), translates along the guide (19) in parallel with the first jaw (6), so that the facing clamping surfaces remain substantially parallel irrespective of the selected opening. When the desired opening has been obtained, releasing the rotation of the female shank (2) allows the ratchet (14) to re-engage the teeth (8) under the action of the elastic element (16), locking the relative position of the shanks (1,2) and maintaining the parallelism of the jaws (6,17) during the subsequent clamping operation.

The technical effect of this embodiment is the improvement of the quality and safety of the grip. By keeping the clamping surfaces substantially parallel, the pressure applied to flat or prismatic workpieces is distributed more uniformly across the contact area, which reduces the likelihood of local marking or damage and improves retention stability. This configuration is particularly advantageous for holding objects with flat or parallel faces, such as nuts, plates, bars or connectors, while preserving the one-hand and ambidextrous operation already provided by the adjustment mechanism (3).

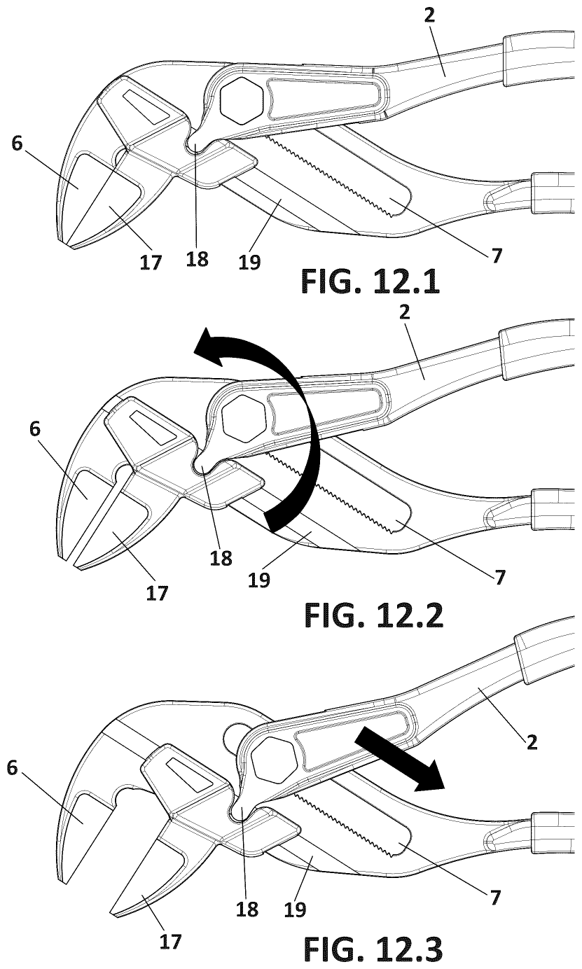

FIGS. 12.1 to 12.3 schematically show the sequence of operation for the alternative embodiment: open, disengaged and closed positions, respectively. In the open position, the jaws (6,17) are separated while maintaining the parallel orientation of their clamping surfaces; in the disengaged position, the rotation of the female shank (2) produces the coupling between the shaft (15) and the ratchet (14) and the consequent release from the teeth (8); and in the closed position, after re-engagement of the ratchet (14), the movable jaw (17) remains parallel to the first jaw (6) for clamping the workpiece.

1. Adjustable opening pliers, comprising:
a passive male shank, comprising consecutively, a first handle, a first intermediate sector and a first jaw, where in the first intermediate sector a longitudinal through slot is located, with teeth defined on its lower internal edge;
an active female shank, comprising consecutively a second handle, a second intermediate sector and a second jaw, where the second intermediate sector has a transverse through channel, for partial insertion of the male shank, and a perpendicular and through side bore, which passes through the female shank at the end of the transverse channel closest to the second jaw; and
an adjustment mechanism insertable at least partially into the side bore,
for adjustable mutual linkage between the male shank and the female shank;
the pliers being characterized in that the adjustment mechanism comprises:
a ratchet, which can be engaged and disengaged with the teeth and is provided with a central through hole; and
a shaft attachable in the side bore and actuatable by rotating the female shank, with a stem configured to interact with the internal surfaces of the central hole of the ratchet;
in which with a turn of the female shank the shaft stem interacts with the internal surfaces of the central hole of the ratchet so that it turns in connection with the shaft to disengage the teeth and subsequently adjust the relative mutual position of the male shank and the female shank.

2. Pliers according to claim 1, wherein the shaft stem has a polygonal geometry.

3. Pliers according to claim 2, wherein the shaft stem has at least two flat sides.

4. Pliers according to claim 3, wherein the shaft stem has four flat sides.

5. Pliers according to claim 1, wherein the adjustment mechanism incorporates an elastic element linked to the ratchet.

6. Pliers according to claim 1, wherein the female shank comprises a movable jaw guided with respect to the male shank, such that the first jaw and the movable jaw remain substantially parallel during adjustment.

7. Pliers according to claim 6, wherein:
the female shank further comprises a protruding part located on an end opposite to that on which the second lower handle is located, which couples the female shank with the movable jaw; and
the male shank further comprises a guide arranged beneath the longitudinal through slot;
so that the protruding part of the movable jaw, through which it is attached to the female shank is displaced in a guided manner along said guide to maintain the parallelism of the clamping surfaces.
